(19) United States
(12) Patent Application Publication
(10) Pub. No.: US 2003/0143978 A1
(43) Pub. Date: Jul. 31, 2003

(54) Wireless telephone call processing

(75) Inventors: John Cooper, Tewksbury, MA (US); John W. Hayes JR., North Reading, MA (US); Peter Zuyus JR., Tulsa, OK (US)

Correspondence Address: WEINGARTEN, SCHURGIN, GAGNEBIN & LEBOVICI LLP, TEN POST OFFICE SQUARE, BOSTON, MA, 02109, US

(73) Assignee: Boston Communications Group, Inc.

(21) Appl. No.: 10/347,110

(22) Filed: Jan. 17, 2003

Related U.S. Application Data
(60) Provisional application No. 60/349,515, filed on Jan. 18, 2002.

(51) Int. Cl. H04M 11/00

(52) U.S. Cl. 455/406; 455/405

(57) ABSTRACT

A system for providing alternative billing and service authorization for pre-paid wireless calls segments call flow to supporting subsystems and limits trunk usage exclusively to short pre- and post-call announcements. An Integrated Services Digital Network User Part (ISUP) Application, hosted by an SS7 Service Switching Point, keeps call state information, implements call-flow capabilities, and accesses resources for messaging. An Intelligent Peripheral (IP) provides an Interactive Voice Response Unit. A Responder serves as an interface to a database of pre-paid plan subscriber information, rates calls, and defines messages to be voiced by the IP. A Call Controller manages call context data for use by the Responder and conveys script information from the Responder to the IP. SS7 ISUP signaling enables out-of-band signaling between a carrier's MSC and the ISUP Application.

### CROSS REFERENCE TO RELATED APPLICATIONS

This application claims priority of U.S. Provisional Patent Application No. 60/349,515, filed Jan. 18, 2002, the disclosure of which is herewith incorporated by reference.

### STATEMENT REGARDING FEDERALLY SPONSORED RESEARCH OR DEVELOPMENT

N/A

### BACKGROUND OF THE INVENTION

Billing and service authorization for wireless telephone calls have typically relied upon two voice channels per call through a regional call interface node having interactive voice response capability. These regional nodes are required to be in continuous communication with a billing services platform for the duration of the call. Each call processed by such a system, from the carrier's Mobile Switching Center (MSC) to the regional node and back to the MSC, requires two voice trunks for the entire length of the conversation, regardless of the length of the call. Separate signaling pathways may also be required, depending upon whether out-of-band signaling is employed between the MSC and the regional node. Typically, such systems have also required dedicated data channels between the multiple regional nodes and the billing services platform.

The inefficient use of voice trunks and data channels are an economic detriment to such a system.

### BRIEF SUMMARY OF THE INVENTION

The presently disclosed call processing architecture segments call flow to supporting subsystems and limits trunk usage exclusively to short pre- and post-call announcements. Carrier trunk expense is thus greatly reduced.

Key components of the system of the invention include an SS7 Service Switching Point (SSP) which hosts an Integrated Services Digital Network User Part (ISUP) Application, an Intelligent Peripheral (IP) having an Interactive Voice Response Unit (IVRU), a Call Controller (CC), and a Responder. A database of subscriber data is also an integral component of this system.

The ISUP Application keeps call state information, implements call-flow capabilities, accesses resources for messaging, and stores Responder context.

The Responder serves as an interface to the database of information relevant to subscribers to a pre-paid wireless service plan or plans. The Responder may thus retrieve data from or write data to the database. Based upon information received from the Call Controller and the associated database, the Responder also serves to rate the call and assemble script information which defines messages to be voiced by the IP. The script information is sent to the IP via the Call Controller and ISUP Application.

The IP has a socket interface to the ISUP Application and the Responder and provides interactive voice response capability, including voiced message delivery and digit collection. It is preferably located proximate carrier MSCs to minimize trunking expense.

The Call Controller manages call context data for use by the Responder, including measured call duration and call duration threshold information. The Call Controller also serves to convey script information from the Responder to the IP. In a first embodiment, redundant Call Controllers are located in central locations. Only one trunk line is briefly required for the Call Controller to convey information indicative of the announcement to be voiced by the IP to the ISUP Application. The Call Controller functionality is focused on call control and not voice response, as in previous systems. With control functionality so separated, calls can be allowed to proceed even if the MSC loses indirect connectivity to the IP.

SS7 ISUP signaling is employed in the presently disclosed system for enabling out-of-band signaling between the MSC and ISUP Application. Such signaling enables telephone equipment of different manufacturers to connect with each other in a network and to exchange messages. T1 lines are used to connect the carrier's MSC to the IP. Unlike the in-band signaling systems of the prior art, the T1 lines are used only for voice communication and not for data. The IP is capable of receiving signaling information over an Ethernet link using a TCP/IP socket connection to the SS7 service platform and is capable of communicating directly with the Responder under certain circumstances, to be described below.

### BRIEF DESCRIPTION OF THE SEVERAL VIEWS OF THE DRAWING

The invention will be more fully understood by reference to the following description in conjunction with the accompanying drawings, of which:

FIG. 1 is a schematic diagram of a pre-paid wireless billing and service authorization platform according to the presently disclosed invention;

FIG. 2 is a glossary of various message types exchanged by and within the presently disclosed invention;

FIG. 3 illustrates the sequential exchanges employed by the presently disclosed system for a successful subscriber-placed outbound call;

FIG. 4 illustrates the sequential exchanges employed by the presently disclosed system for an unsuccessful subscriber-placed outbound call;

FIG. 5 illustrates the sequential exchanges employed by the presently disclosed system for a successful inbound call to a subscriber;

FIGS. 6A through 6C illustrate the sequential exchanges employed by the presently disclosed system for associating a subscriber to a respective subscriber database entry;

FIG. 7 illustrates the sequential exchanges employed by the presently disclosed system when a level of credit associated with a subscriber database entry falls below a specified level;

FIGS. 8A through 8B illustrate the sequential exchanges employed by the presently disclosed system for a subscriber-to-subscriber call;

FIG. 9 illustrates the sequential exchanges employed by the presently disclosed system in enabling a subscriber to query the available balance in a respective subscriber database entry;

FIG. 10 illustrates the sequential exchanges employed by the presently disclosed system in enabling a subscriber to replenish the level of credit associated with a respective subscriber database entry;

FIGS. 11A and 11B illustrate the sequential exchanges employed by the presently disclosed system in notifying a calling subscriber of a low balance in a respective subscriber database entry and in enabling the subscriber to replenish the level of credit associated with the respective database entry;

FIG. 12 illustrates the sequential exchanges employed by the presently disclosed system in enabling a subscriber to query the available balance associated with a respective subscriber database entry;

FIGS. 13A through 13C illustrate the sequential exchanges employed by the presently disclosed system in enabling the use of the system in conjunction with roaming callers; and

FIG. 14 illustrates the sequential exchanges employed by the presently disclosed system in enabling the use of the system in conjunction with only selected roaming callers.

### DETAILED DESCRIPTION OF THE INVENTION

The presently disclosed system provides an alternative billing and service authorization platform for integration with equipment belonging to wireless service providers. The system is capable of being integrated into a standard wireless service provider's platform by associating certain subscriber identifiers with the system.

The system call processing architecture takes advantage of SS7 out-of-band signaling in segmenting call flow into supporting subsystems and limiting trunk usage between the billing and service authorization platform equipment and its carrier-customers exclusively to short pre- and post-call announcements, thus reducing trunking expense associated with “back-hauling” such message traffic. The presently disclosed system does not operate as a switch for calls routed through it. Rather, account-related exchanges with a calling subscriber are implemented before and optionally after a call to a dialed destination.

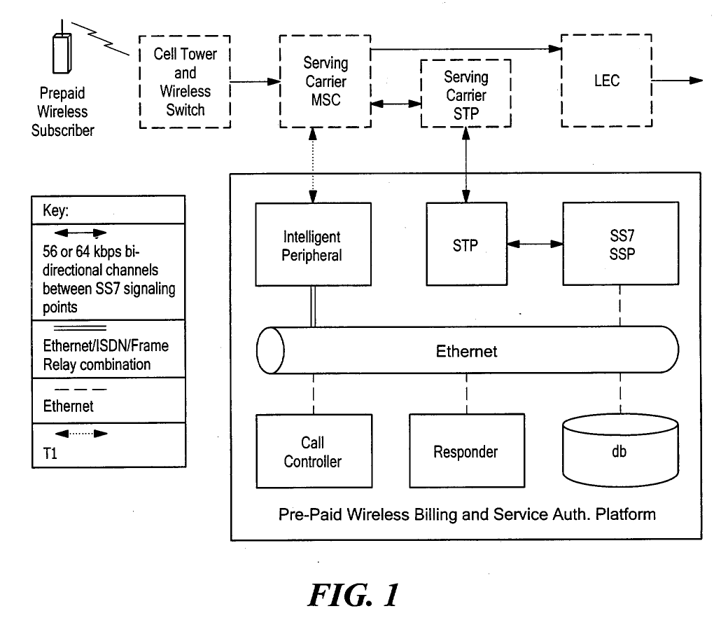

With reference to FIG. 1, the principal components of the system include: a subscriber database (db) of subscriber account information; a Responder serving as an interface to the subscriber database; an Intelligent Peripheral (IP) for voicing messages including messages regarding account balance to a subscriber before and after a call and optionally for collecting subscriber input through dialed digit collection; a Call Controller (CC) for directing call-processing and call-control; and an SS7 Service Switching Point (SSP) hosting an Integrated Services Digital Network User Part (ISUP) Application and an SS7 stack for interfacing with the carrier-customer's equipment.

The cell tower, wireless switch, MSC and associated STP are all part of the serving carrier's service realm. A Local Exchange Carrier (LEC) is a wireline carrier serving a certain geographic region and in the illustrated example serves to interface the wireless calls handled by the serving carrier to a wireline network.

The subscriber database is indexed by a subscriber identifier such as a Mobile Identification Number (MIN). Each subscriber record comprises a large number of parameters characterizing the respective subscriber's account. For instance, while one value associated with a subscriber's account is a current balance, each record may also maintain an identification of: various applicable charge rates depending upon the call type and time; an identification of default air, long distance, home and international carriers; free minutes and rates to which they are applicable; reward type, balance, and expiration date; payment history; account security information; Intelligent Peripheral (IP) Voice Response Unit (VRU) language; credit card number and expiration date; and dates of account creation, activation, and scheduled termination, among other values. The subscriber database may be supported by any suitable persistent data memory system, including hard disk drives, RAID system, tape drive system, floppy diskette drives, optical media drives, etc.

Access to the subscriber database is provided by the Responder. The Responder may be provided as a specially-programmed general purpose computer or may be implemented as a customized data accessing and processing device. In addition to interfacing with the subscriber database for data retrieval and updating, the Responder is responsible for call rating (e.g., determining a maximum call duration) based upon call-related data and subscriber record data and for generating a message script information file for use by the Intelligent Peripheral VRU. Communication between the Responder and the subscriber database is preferably via an Ethernet connection.

The Call Controller (CC) is in communication with the Responder via a data network such as an Ethernet. The Call Controller provides call-processing functions based upon call-related data provided by the ISUP Application and maximum allowable call duration for the respective subscriber provided by the Responder. The Call Controller also provides flow control for message scripts to the Intelligent Peripheral and times the call once the call is connected from the caller to the call-recipient. The Call Controller also stores call context (e.g., rate plan, rate amounts, rate period start and end) for the Responder while a call is set up and in progress.

The SS7 SSP, running the ISUP Application, acts as an interface between a Mobile Services Switching Center (MSC) of a serving carrier and the subscriber data accessed by the Responder. The serving carrier may be the subscriber's home wireless service provider, or may be a third party service provider. Signaling information in SS7 format is conveyed through a separate SS7 data network in the industry-standard ISUP format. More information about each call can be provided as compared to in-band signaling. The ISUP Application keeps call-state information (e.g., an indication of messages have been received and sent including relevant parameters such as ANI, DNIS, etc.), implements call-flow capabilities, accesses messaging resources, and stores Call Controller context. In an alternative embodiment, the ISUP Application also stores Responder context. Intermediate the serving carrier's MSC and the SS7 SSP are respective industry-standard Signal Transfer Point (STP) nodes.

The Intelligent Peripheral includes a Voice Response Unit (VRU) which is provided with script message information by the Call Controller via TCP/IP socket connection with the ISUP Application. The Intelligent Peripheral is in communication with the serving carrier via a T1 connection established at the beginning and optionally at the end of each subscriber-originated call (described in further detail below). The Intelligent Peripheral is principally concerned with playing voice messages based upon the script message information and collecting digits transmitted to it. TCP/IP is employed as the protocol between the Intelligent Peripheral, ISUP Application, and Responder. The Intelligent Peripheral is preferably located proximate one or more serving carrier locations (regionally or co-located) in order to minimize the distance between the Intelligent Peripheral and MSC, whereas the SS7 SSP, Call Controller, Responder, and subscriber database are typically provided at locations remote from the service providers.

The serving carrier must configure its MSC to provide loop-around trunk groups, as well as trunk groups that connect to the Intelligent Peripheral. In addition, the MSC must provide Temporary Local Directory Numbers (TLDNS) for connecting calls to the Intelligent Peripheral.

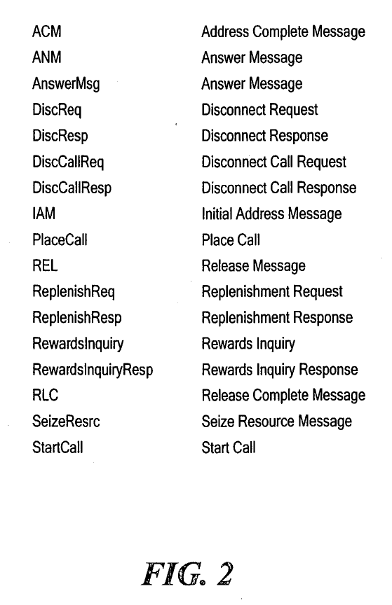

In the following, certain call types are explained on a step-by-step basis in conjunction with the figures. In most instances, each step in the call flow depictions represents the exchange of an SS7 signaling message between the serving carrier's MSC and the presently disclosed system or solely within the presently disclosed system. FIG. 2 provides a brief glossary of certain signaling messages used in those exchanges.

System Subscriber Registration

Registration of a system subscriber's wireless phone occurs in the same manner as registration of an industry-standard postpaid wireless phone. For example, when a subscriber activates his/her wireless telephone, the telephone scans forward channels for the strongest signal, then transmits the subscriber's Mobile Identification Number (MIN), the wireless telephone's Electronic Serial Number (ESN), and an identification of the subscriber's home service provider.

The serving carrier's wireless switch conveys this information to the respective MSC, which in turn informs the subscriber's home service provider, which may or may not be the serving carrier depending upon whether the subscriber is roaming, of the registration. The home service provider replies to the MSC of the serving carrier with subscriber profile data to be used by the serving carrier in determining how calls to or from the subscriber are to be processed.

In the case where the subscriber is roaming outside the home service provider's service area, the returned profile information is stored in a Visitor Location Register (VLR) associated with the serving carrier's MSC. If the subscriber registers within the home service provider's service area, call processing information is stored in a Home Location Register (HLR). In either case, the stored profile information is used by the MSC in determining how calls to or from the subscriber are to be handled.

In all respects, the processes executed by and the functionalities of the prepaid system subscriber's wireless telephone, the serving carrier, and the subscriber's home service provider are essentially the same as those executed in the case of non-prepaid wireless telephone users. Subscriber registration differs only in the content of the profile information returned by the home service provider.

Subscriber-Placed Outbound Call

The response by a serving carrier to the initiation of a call placement request from a system subscriber is the same as that for a call request by a non-prepaid customer. Following an exchange of control information between the wireless switch and the wireless phone, including the identification of a voice channel to be used, the wireless phone transmits the respective Automatic Number Identification (ANI) code (which includes the subscriber's MIN), the ESN, and the Dialed Number Identification System (DNIS) code.

In one instance, the serving carrier for a subscriber-initiated call is the subscriber's home service provider. In this case, the MSC of the serving carrier refers to a respective Home Location Register (HLR), a database that contains profile data associated with subscribers, in order to verify that the Mobile Identification Number (MIN) of the caller, provided by the wireless phone, is associated with a valid subscriber account. HLR data is typically indexed according to a MIN associated with either the calling or called party.

In a second instance, the serving carrier is not part of the subscriber's home system, in which case the subscriber is said to be roaming. As previously described, the MSC of the serving carrier creates an entry for the roaming caller in its VLR based upon subscriber profile information received during wireless telephone registration.

The HLR data for a local subscriber and the VLR data for a roaming subscriber are used to identify whether the calling party is a subscriber to the presently disclosed pre-paid billing and service authorization system. This identification can be carried out in one of at least two ways. In a first instance, the serving MSC is provided with one or more ranges of Numbering Plan Area central office code (NPA/NXX) numbers identified as being associated with a particular class of service. The MSC is programmed to send an address request to the present system via an SS7 signaling channel while the call is looped back to the MSC. In a second instance, the HLR or VLR data in the serving MSC includes a class of service indicator. A subscriber has a particular class of service definition in its respective HLR/VLR profile, and the MSC of the serving carrier is programmed to submit an address request to the presently disclosed system via an SS7 signaling channel while the call is looped back to the MSC.

From the perspective of a subscriber to a pre-paid cellular service employing the presently disclosed billing and service authorization system, a successful outbound call involves dialing the desired telephone number, receiving pre-call announcements, being connected to the dialed number, optionally receiving post-call announcements, and hanging up. Typically, pre-call announcements indicate the amount of time available for the particular call, and post-call announcements relate account status following the call.

The call proceeds in “legs” or connections. These legs are for: triggering subscriber account access; pre-call rating and VRU script construction; connecting the calling subscriber to the Intelligent Peripheral to enable the voicing of subscriber account-related scripts before and after the call is connected and optionally to receive data from the subscriber in the form of dialed digits; and connecting the subscriber to the called number.

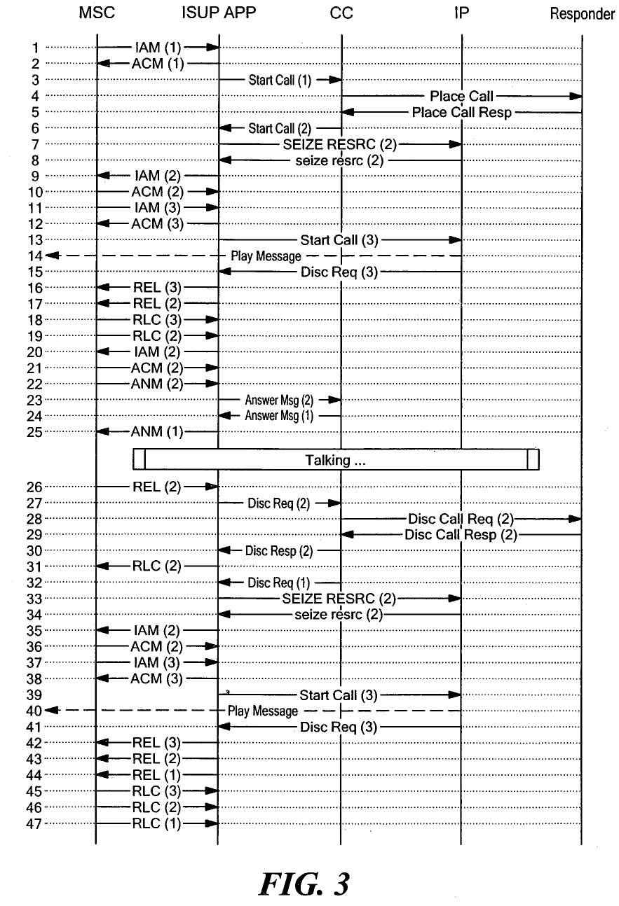

In summary, and with reference to FIG. 3, the call flow proceeds as follows. A call originating from a pre-paid subscriber is identified by the MSC by reference to a location register using the caller's MIN as an index value. The MSC responds by requesting an address via a first leg to the present system (lines 1-2). The ISUP Application provides the Call Controller with the call particulars, including the calling subscriber's MIN and the dialed DNIS, which are forwarded to the Responder for call rating based on the respective account information in the subscriber database and on the call particulars. The Responder generates voice message script information and passes this to the Call Controller, which forwards it to the ISUP Application for buffering. The Responder also calculates a maximum call duration based upon whether the call is local, long distance or international, time of day, and subscriber rate, credit, and account balance information, then forwards this maximum call duration value to the Call Controller for subsequent call timing (lines 3-6).

In one embodiment of the presently disclosed system, the ISUP Application communicates with the Intelligent Peripheral to obtain an available TLDN for leg 2, which will be used to provide the pre-call announcement to the calling subscriber (lines 7-8). In a second embodiment, not illustrated, available TLDNs are already identified to the ISUP Application so there is no need for the ISUP Application to request this information from the IP. The ISUP Application then initiates leg 2 by sending the TLDN to the MSC. After acknowledging receipt of the TLDN, the MSC recognizes the TLDN value as being associated with the pre-paid billing system and responds with a request to start leg 3 (lines 9-11). After acknowledging receipt of the leg 3 call request, the ISUP Application forwards the call request to the Intelligent Peripheral along with the previously buffered voice script information and the TLDN. The Intelligent Peripheral then voices the scripted pre-call message to the subscriber via the MSC (lines 12-14). The IP may also be employed for digit collection, for instance to enable a subscriber to update their account credit level.

When the pre-call message is complete, the Intelligent Peripheral instructs the ISUP Application to disconnect leg 3 (line 15), and the ISUP Application likewise instructs the MSC to release leg 3 (line 16). The ISUP Application also instructs the MSC to release leg 2 (line 17). After confirming release of legs 2 and 3, the ISUP Application starts a new call for leg 2 by sending an initial address message to the MSC along with the buffered destination number dialed by the subscriber (lines 18-20). The MSC confirms receipt of the initial address message, forwards the call to the Local Exchange Carrier (LEC) for call completion, and, once the call is completed to the dialed party, sends an answer message to the ISUP Application for leg 2 (lines 21-22).

The ISUP Application informs the Call Controller that the leg 2 call has been answered (line 23), resulting in the initiation of a call timer in the Call Controller. The Call Controller responds to the ISUP Application with an answer message for leg 1 (line 24), indicating that call timing is in progress and to connect the call to the subscriber. This is accomplished by the ISUP Application sending an answer message to the MSC to finish the call set-up sequence (line 25). The calling subscriber and the dialed party are now connected.

If the called party hangs up before the calling subscriber, the MSC sends a release message to the ISUP Application for leg 2, which results in appropriate messages, including call context information, being sent by the ISUP Application to the Call Controller for cessation of call timing and subsequently to the Responder (lines 26-28). The Call Controller also provides the Responder with a call duration value to enable call accounting and subscriber database up-dating by the Responder. The Responder then sends a post-call VRU message script to the Call Controller, which forwards the message script to the ISUP Application for buffering (lines 29-30). The ISUP Application then sends a release confirmation message to the MSC for leg 2 (line 31).

The Call Controller at this time also sends the ISUP Application a disconnect request for leg 1. The ISUP Application responds by either requesting and receiving a new TLDN from the Intelligent Peripheral for leg 2 or looking up an available one of the pre-stored TLDNs. The ISUP Application then starts the call for leg 2 by sending the TLDN to the MSC (lines 32-35). After confirming receipt of the TLDN to the ISUP Application, the MSC starts a new call for leg 3 by sending an initial address message to the ISUP Application. This message is confirmed, then the ISUP Application informs the Intelligent Peripheral to start the call and provides it with the previously buffered message script, which is used to generate a voiced account status message to the calling subscriber over leg 3 (lines 36-40).

Once the voiced message is complete, the Intelligent Peripheral requests the disconnection of leg 3 (line 41), and the ISUP Application responds by sending release requests for legs 3, 2 and 1 to the MSC. Once confirmed, the call sequence is complete (lines 42-47).

In the instance where the calling subscriber hangs up prior to the playing of the voiced account status message, the establishment of leg 3 (lines 33 et seq.) is omitted.

Unsuccessful Subscriber-Placed Outbound Call

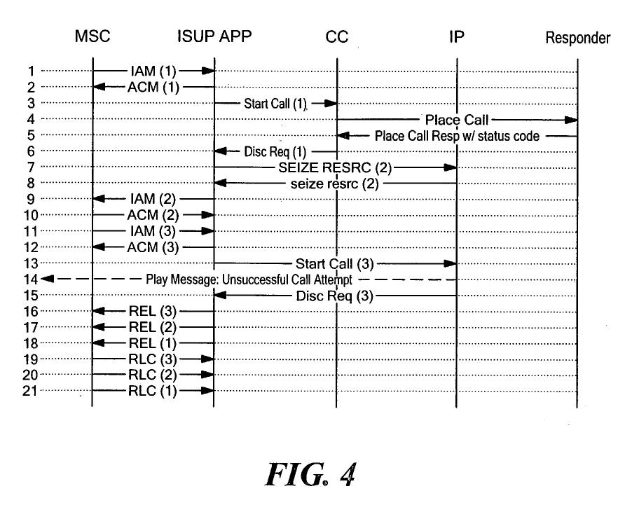

A determination that a pre-paid system subscriber call cannot be completed may be the result of various factors, including insufficient funds or credits associated with the subscriber's account, an inability by the Responder to locate a record associated with the subscriber, an indication associated with the subscriber's account that a call to the dialed number is not allowed (i.e., the call is blocked), or some other indicator associated with the subscriber's account that the service cannot be provided. In all cases, the call sequence depicted in FIG. 4 is identical to that of a successful call through the provision of the initial voice message to the calling subscriber (FIG. 4, line 14), except that the message initially defined by the Responder and provided to the Intelligent Peripheral following buffering by the ISUP Application indicates that the call attempt is unsuccessful. Additional information relating to the cause of the failed attempt may optionally be provided and account-related input from the subscriber may be received.

Following the voicing of this account status message, the Intelligent Peripheral requests the ISUP Application to tear down the three legs with the MSC (lines 15-21).

Successful Inbound Call to Subscriber

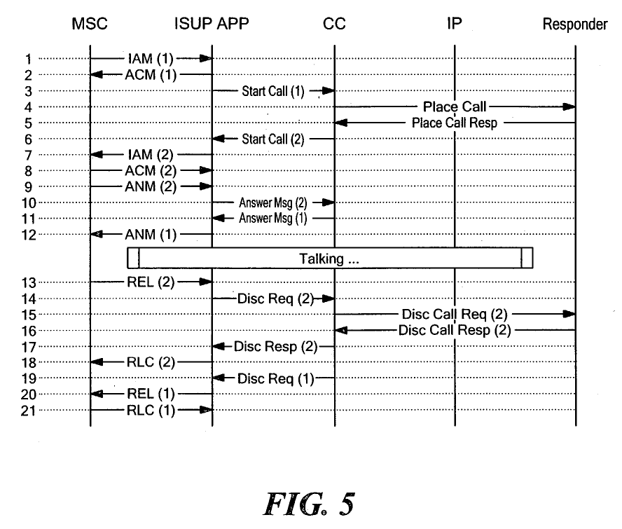

In the case where a third party calls a pre-paid system subscriber, no pre- or post-call messages are conveyed to the dialed subscriber. With respect to FIG. 5, the MSC looks up the received Dialed Number Identification Service (DNIS) code in a location register associated with the MSC and initiates a first call for leg 1 to the ISUP Application (line 1). Call acknowledgement is provided to the MSC, and the Call Controller forwards the call-related data to the Responder for subscriber account accessing and data retrieval. Once the proper account information has been retrieved by the Responder and minimum criteria for the call to proceed have been confirmed, the Responder instructs the Call Controller to start the call on leg 2 (lines 2-6). This is accomplished by the ISUP Application sending an initial message for leg 2 to the MSC, which acknowledges the message, dials the subscriber, and provides an answer message to the ISUP Application and Call Controller (lines 7-10). The Call Controller then instructs the ISUP Application to answer the call for leg 1, thus completing the call to the subscriber (lines 11-12). The call timing is initiated at this point by the Call Controller.

Once either party has hung up, the MSC instructs the ISUP Application to release the call for leg 2. A release request is then forwarded to the Call Controller, which then forwards call duration information to the Responder with the disconnect request (lines 13-15). The Responder performs account updating based upon the data from the Call Controller, then provides updated information to the subscriber database after call disconnection.

A call disconnect request acknowledgement is passed from the Responder to the Call Controller to the ISUP Application, where an industry-standard call disconnect message is forwarded to the MSC (lines 16-18). The Call Controller then instructs the MSC, via the ISUP Application, to disconnect leg 1. Upon confirmation of the leg 1 disconnect request, the call sequence is complete (lines 19-21).

Unsuccessful Inbound Call to Subscriber

Factors similar to those outlined with respect to an unsuccessful outbound call may also result in an unsuccessful inbound call to a pre-paid system subscriber. In this case, essentially the same call sequence depicted in and described in conjunction with FIG. 4 is carried out, ultimately resulting in the voicing of an appropriate message to the calling party (FIG. 4, line 14). In the instance where the subscriber account has expired or has been suspended, the caller may hear a message indicating that the call cannot be completed. In the instance where the subscriber's account balance, in terms of monetary units and/or credits, is insufficient to fund a minimum quantum of telecommunications service, the message may indicate that the called party is unavailable and that the call should be attempted later.

Association Call

An association call takes place upon the initial instance of pre-paid system use by a new pre-paid wireless subscriber. The association call may be customized for the respective carrier employing the pre-paid billing and service authorization system. Typically, such an association call message requests the entry of a subscriber card or other identification number.

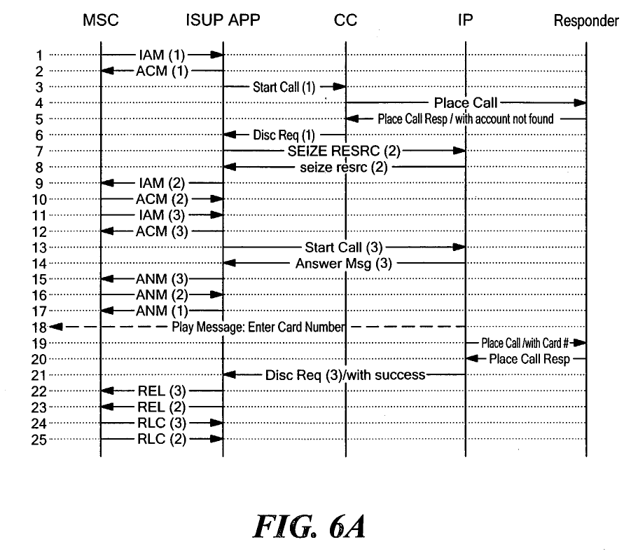

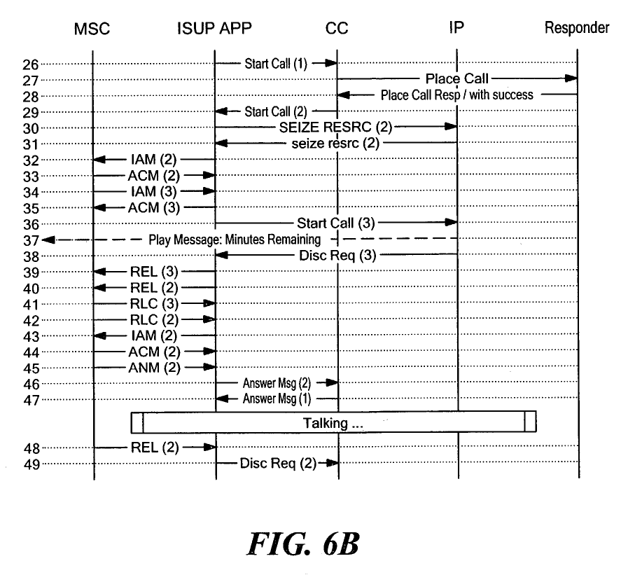

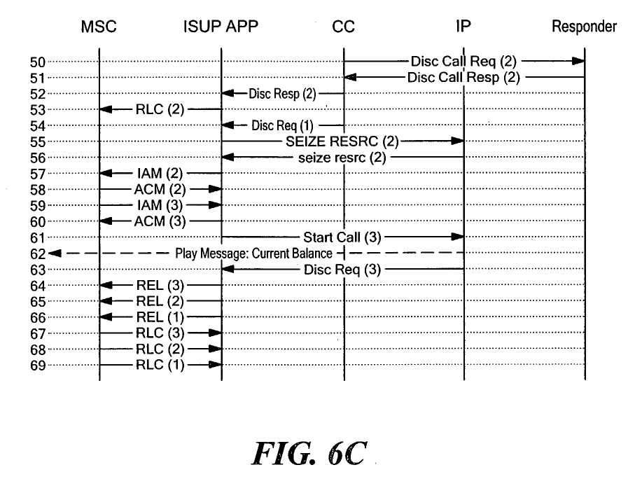

With reference to FIG. 6A, the initial interaction between the serving carrier's MSC and the pre-paid billing system components is similar to a normal subscriber-initiated call. That is, the MSC initiates leg 1, and the Responder provides the Call Controller with a voice message script requesting entry of a subscriber account number (lines 1-5). This is the result of the Responder being unable to match the new subscriber's MIN to a respective account in the subscriber database. The appropriate script information is buffered by the ISUP Application while a resource request is sent to the Intelligent Peripheral or the required resource is identified in association with the ISUP Application, the initiation of leg 2 (lines 7-8).

Once a TLDN has been identified, the ISUP Application sends an initial address message to the MSC along with the TLDN. The MSC replies by sending an initial address message to the ISUP Application for leg 3 (lines 9-12). The ISUP Application then provides the buffered message script to the Intelligent Peripheral, and the message requesting entry of subscriber data is voiced over the T1 connection between the Intelligent Peripheral and the MSC and the MSC to the calling subscriber (lines 13-18). Once keyed in by the subscriber and buffered in the Intelligent Peripheral, the subscriber data is forwarded by the Intelligent Peripheral directly to the Responder via TCP/IP socket connection (line 19). The direct communication between the Intelligent Peripheral and the Responder results from the size of the data field required by the association call. If this data were to be provided via the ISUP Application, the default data field size exchanged between the IP and the ISUP Application would have to be large enough to accommodate association call data. Since such calls are relatively infrequent, such large data field would normally go unused and would slow down communications between the IP and remainder of the system.

The second and third legs are then released (lines 20-25), following which out-going call processing resumes, as described above. Specifically, FIGS. 6B and 6C, lines 26 through 69, essentially replicate the successful outbound call steps of FIG. 3, lines 3 through 47.

Depleted Account Call Interrupt

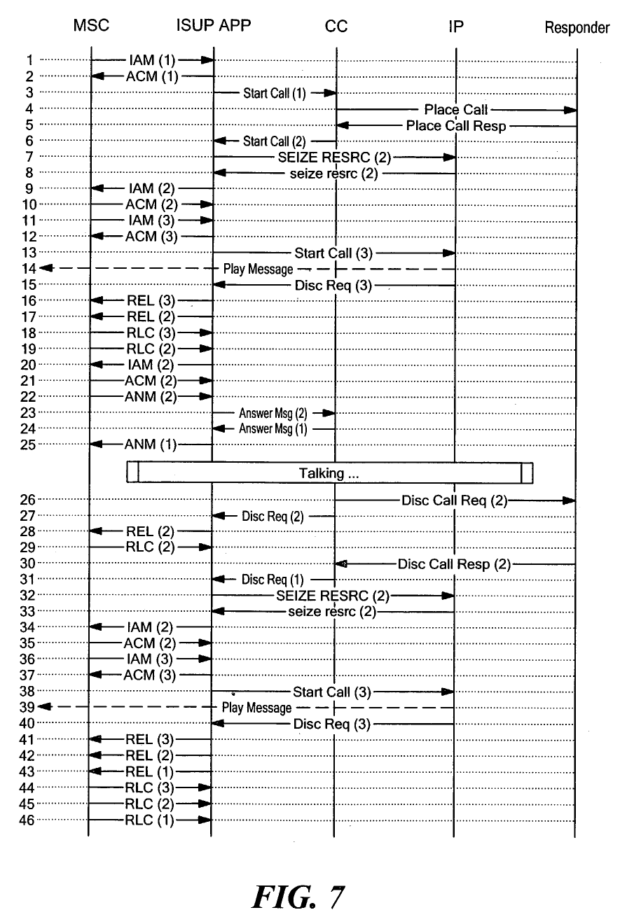

While sufficient credit may exist at the initiation of a call to or from a pre-paid subscriber to fund a minimum quantum of telecommunications service, the call may exceed a maximum call duration pre-calculated by the Responder based upon the subscriber's account data and upon the DNIS. The Call Controller is responsible for determining when the maximum call duration has been reached. As illustrated in FIG. 7, the same call establishment procedure as shown in FIG. 3 is employed to the point at which the calling and called parties are conversing. However, if the maximum call duration is met, the Call Controller sends a disconnect request to the Responder, by which the subscriber's account is adjusted accordingly, and to the ISUP Application for generating a new disconnect message to the MSC (FIG. 7, lines 26-29). A new T1 voice channel between the MSC and the Intelligent Peripheral is set up as above in order to convey a depleted balance message, defined by the Responder, to the subscriber (lines 30-39). The call is then terminated (lines 40-46). Optionally, the calling subscriber may be provided with an opportunity to replenish the respective account balance. The call between subscriber and third party must then be reestablished by the placement of a new call.

Successful Subscriber-to-Subscriber Call

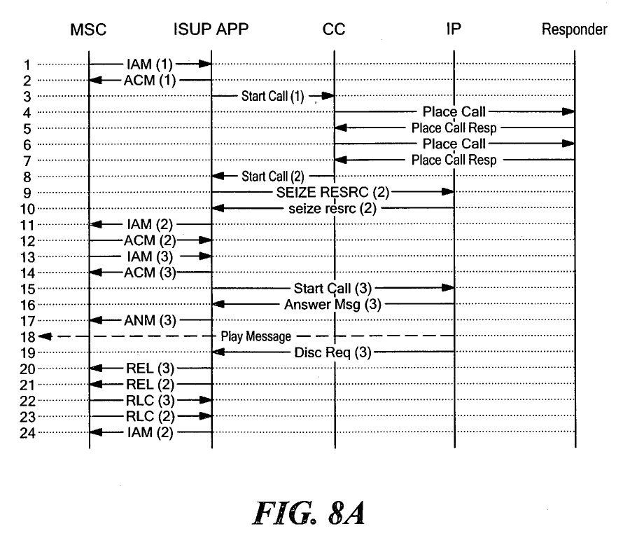

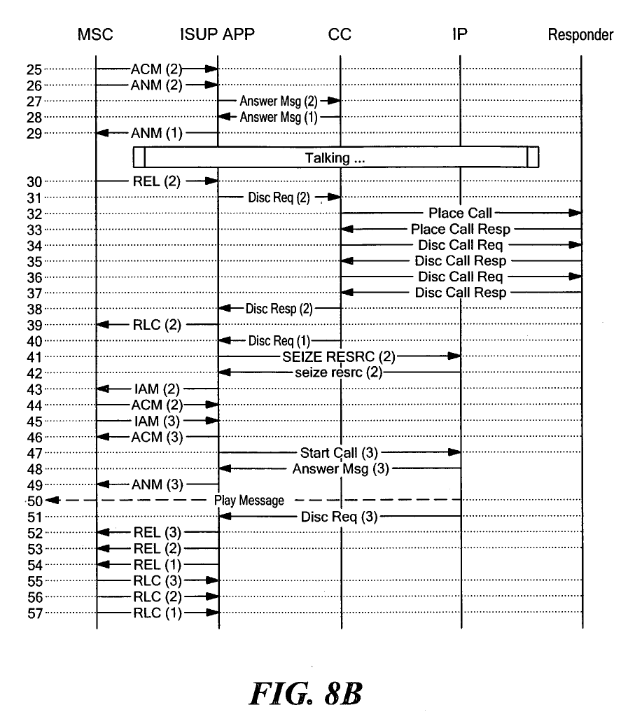

In the case where one pre-paid system subscriber calls another pre-paid system subscriber, the call flow is substantially similar to that of a successful call where only the calling party is a subscriber. With reference to FIG. 8A, the difference lies in that the Call Controller sends two “place call” messages to the Responder, one for each subscriber (lines 1-7). The Responder then calculates the amount of time available based upon data from each account, and provides the calculated times to the Call Controller (lines 5 and 7). The Call Controller sets a timer for the call based upon the smaller of the two time values and limits the call duration to this amount of time. The Call Controller then instructs the ISUP Application to start the call, which includes requesting and receiving a TLDN from the ISUP Application (lines 9 and 10) in the case where the ISUP Application does not already have knowledge of such resources. Meanwhile, a message script is provided by an Intelligent Peripheral to the calling party announcing the availability of a time value calculated from the calling party's account record (lines 11-23). The time value announced to the calling party may or may not be the amount of time which defines the maximum call duration. The call is then established (lines 24-29) as in a successful subscriber-placed outbound call, described above.

At the completion of the call, the Call Controller sends a request to the Responder to retrieve the account information for the subscriber that had the larger available credit balance (lines 30-33). In an alternative embodiment, the Call Controller has retained the subscriber information during the call, thus eliminating the subscriber data request to the Responder. The Call Controller then sends call disconnect messages to the Responder for each subscriber (lines 34-37), thus causing the updating of both accounts. The post-call announcement to the calling subscriber is then played (lines 38-50) before the call is torn down (lines 51-57), as in a successful subscriber placed outbound call as described above.

In a further embodiment, calls from one customer of a carrier to another, as identified by the Responder, may be rated according to special, discounted rate plans.

Account Status and Account Replenishment Calls

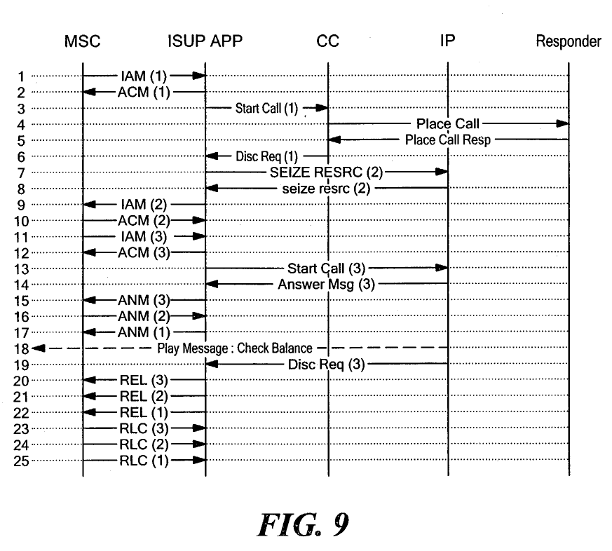

Other types of subscriber calls which are enabled by the presently disclosed pre-paid billing and service authorization system include a “check balance” call, by which a subscriber can query the available credit balance associated with the respective account. The steps involved in a check balance call are illustrated in FIG. 9. The MSC provides a message to the ISUP Application indicating the call from the subscriber (lines 1 and 2). The ISUP Application notifies the Call Controller, and a place call request is sent to the Responder (lines 3-4). The Responder replies with subscriber account data (line 5). A disconnect request from the Call Controller to the ISUP Application results in a request to the IP for a TLDN (lines 6-8), which is then forwarded to the MSC and a voice connection is established to the IP (lines 6-18). The script info previously provided to the IP includes the calling subscriber's account information. After it has been voiced by the IP, the call is torn down as above (lines 19-25).

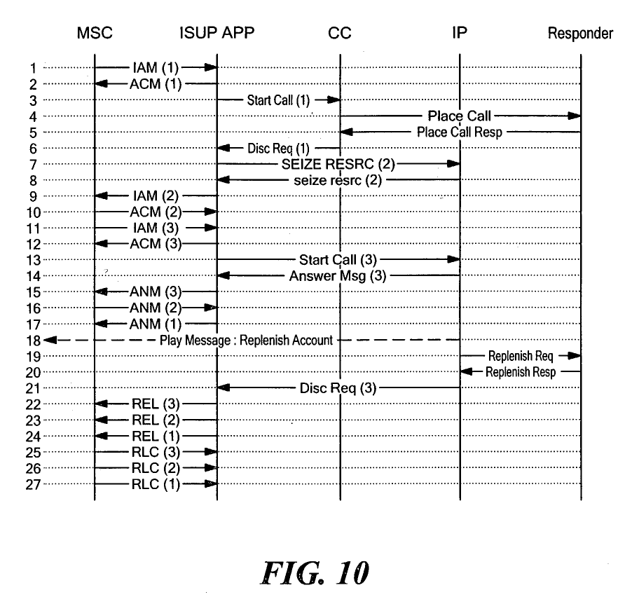

Another type of subscriber-initiated call is an “account replenishment” call, by which a subscriber can augment the level of credit reflected in their account. As shown in FIG. 10, the account replenishment call involves the same steps as the check balance call, except that for replenishment the IP receives input from the subscriber which is conveyed directly to the Responder (lines 19-20). By-passing the ISUP Application and Call Controller enables a smaller default data field size for IP-ISUP Application messages, as discussed above with respect to the association call.

Both of these types of calls can be accomplished by the subscriber entering a special dialing string such as 611 on his/her wireless phone followed by the SEND key or, if calling from a land line phone, dialing a toll-free number to reach a customer care service of the pre-paid billing system. This customer care service is preferably an interactive voice prompted service which provides several services including account replenishment using a credit card or pre-paid card, account balance information reporting, account profile customization, and connection to a customer service representative.

The subscriber is prompted to enter his/her ten digit mobile telephone number and, if recognized to be a valid number by the Responder, the subscriber is given several menu choices via the Intelligent Peripheral VRU, one of which is to add credit to the account. For example, the subscriber is prompted to press 2 if the choice is to add credit to the account. After pressing 2, the subscriber is prompted to enter his/her multi-digit pass code and if a correct code is entered, as recognized by the Responder, the subscriber is provided with choices to add credit to the account by credit card or by pre-paid card. Menu prompts are defined by the Responder and forwarded to the Intelligent Peripheral by the ISUP Application.

The subscriber is prompted to press 1 to add credit to the account by pre-paid card, and is then prompted to enter the card number followed by the # key. Upon entry of a correct pre-paid card number, as determined by comparison of the entered card number with a database of valid numbers accessed by the Responder, the credit associated with the card number is added to the subscriber's account and an announcement is made of the subscriber's then-current balance in the account.

The specific keys and abbreviated dialing sequences identified in the foregoing are used to demonstrate the concept and should not be viewed as limiting.

The pre-paid billing and service authorization platform operator issues pre-paid card numbers to wireless service providers with an optional carrier-defined shelf-life. Typically, this shelf-life period is one year. The Responder determines by reference to the pre-paid card database if the prepaid card number is still valid for use, i.e., if the shelf-life associated with the card number has not expired. If determined to be valid, the pre-paid card is accepted by the pre-paid billing and service authorization system and a respective subscriber account is credited accordingly. A message is provided to the subscriber by the Intelligent Peripheral VRU indicating that the account balance credited by the respective card is available for a predetermined number of days, otherwise referred to as an expiration period.

If, however, the shelf-life of the entered card number is determined to have expired, the subscriber is advised of the expired status and is prompted to return to the main menu or to hang up.

If an invalid card number is entered, such as from a prepaid card already used, as determined by the Responder accessing the database of card data, the subscriber is informed by voice message that the entered number is invalid and is requested to enter the number again followed by the # key. In one embodiment, three attempts at card number entry are permitted; after the third try, if the card is still determined to be invalid, the user is requested to wait for a service representative for assistance.

The pre-paid billing and service authorization system also provides account replenishment by a short dialing sequence. For example, a subscriber enters #ADD on his/her wireless phone (or some similar custom string) then presses the SEND key. By this abbreviated entry sequence, the subscriber reaches the menu for account replenishment using a pre-paid card without the need of proceeding through various menu choices as described above, including required entry of a subscriber mobile telephone number and multi-digit pass-code. The Intelligent Peripheral voices a message prompting the subscriber to enter his/her new pre-paid card number, collects the digits as they are entered, then forwards the card data directly to the Responder. The Responder verifies the validity of the card data, adjusts the subscriber account accordingly, and prompts the VRU to return the updated account balance information to the subscriber.

If a subscriber attempts to place a call with an account balance which is below a pre-determined threshold, a “low balance/account replenishment” message is initiated by the presently disclosed system. A menu-driven session similar to that described above is commenced by the Responder by which the subscriber is notified of the low-balance condition and is given the opportunity to replenish the level of credit in the respective account by use of a menu of options including pre-paid card or credit card.

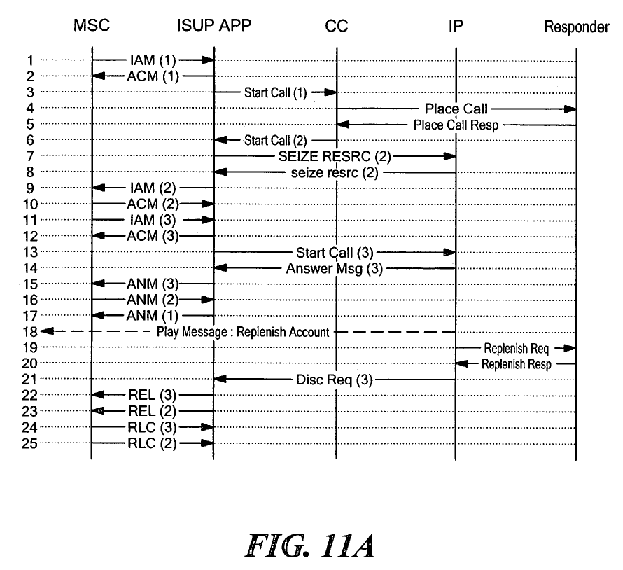

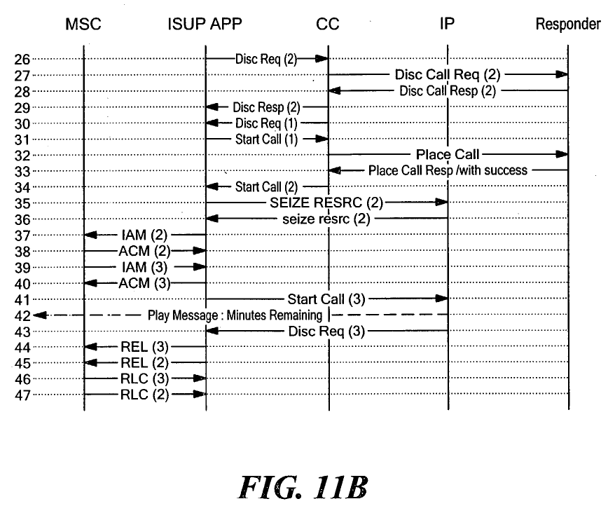

A shown in FIGS. 11A and 11B, the basic call flow includes the MSC signaling the ISUP Application that a call is being initiated by a subscriber having a certain MIN and who has dialed a given DNIS code (lines 1-4). The Responder checks the Subscriber Database, and provides the appropriate message script to the ISUP Application, via the Call Controller, for buffering (lines 5-6). Meanwhile, the ISUP Application causes the Intelligent Peripheral to provide an available TLDN (lines 7-8) or identifies an available TLDN from local memory for forwarding to the MSC (line 9). The message script is sent to the Intelligent Peripheral for being voiced to the subscriber by the Intelligent Peripheral VRU over the T1 connection to the MSC (lines 10-17). After the script is voiced, account-replenishing input from the subscriber is buffered by the Intelligent Peripheral and subsequently provided directly to the Responder (lines 18-19). The Responder updates the subscriber's account and the IP indicates to the ISUP that this has occurred (lines 20-21). The ISUP Application causes legs two and three to be torn down (lines 22-29), then initiates a new call through the Call Controller to the Responder (lines 31-32). The response from the Responder includes updated account information in the form of a new message script. This is passed to the ISUP Application via the Call Controller (lines 33-34). Once again, the ISUP Application responds by requesting a resource from the IP (lines 35-36) or by looking up the required resource in local memory. The previously described steps for establishing communication between the IP and the calling subscriber are carried out before the call is torn down completely (lines 37-47).

Successful Outbound Call with Rewards

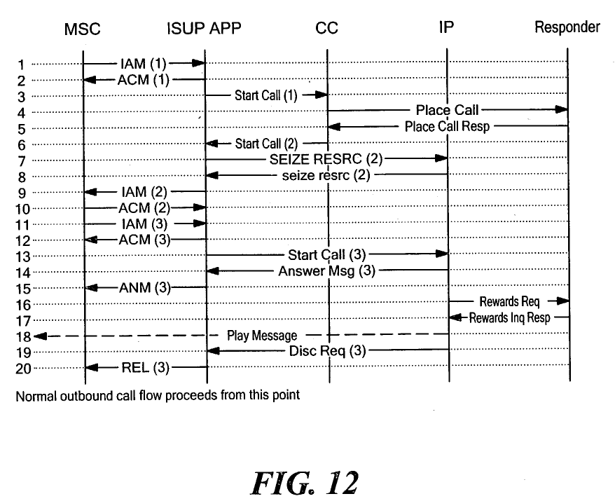

An alternative to the successful outbound call flow as described above involves an announcement that certain credits or reward units are available for use. Such rewards units are typically measured in terms of minutes of free or discounted use or monetary units. While the call flow shown in FIG. 12 is similar in most respects to a subscriber-placed outbound call, the initial message script returned by the Responder to the ISUP Application via the Call Controller (lines 5-6) indicates that reward units or other credits are available. Rewards are credited at the beginning of a call. In response to this message, the Intelligent Peripheral submits an inquiry to the Responder for data (lines 16-17) which will, when inserted in the script identified by the Responder to the Intelligent Peripheral via the ISUP Application and voiced by the Intelligent Peripheral, indicate to the subscriber the amount of credits available (lines 18-20).

In one embodiment of the presently disclosed system, rewards remain available in a subscriber's account until expired or until a voice session between the Intelligent Peripheral and the subscriber has resulted in the subscriber being informed of the rewards. The Intelligent Peripheral determines whether a disconnect request occurred prior to the complete voicing of the rewards message and if not returns the current date to the ISUP Application in a data field indicative of “last rewards date.” This information is then passed to the Responder for recording in the subscriber's record. If, on the other hand, the subscriber did not have an opportunity to hear the entire rewards message, as indicated by a disconnect request occurring prior to the end of the voiced rewards message, the Intelligent Peripheral does not return the current date in the “last rewards date” field, and the Responder does not update this field in the subscriber's record. The rewards will thus remain available for use until expired or until the subscriber listens to the entire rewards message during a subsequent notification attempt. Both the pre-call and post-call messages reflect the change in the subscriber's credit due to the reward.

Hotline Roaming Call

This call type occurs when a prepaid subscriber roams into another carrier's market and that other carrier uses the presently disclosed system for billing and service authorization and if the subscriber's home carrier has configured the subscriber's account for Hotline Roaming. In this case, the serving MSC initially routes the call to the presently disclosed platform by replacing the originally dialed number with a Hotline Roaming number. The latter is preferably provided as a toll-free number.

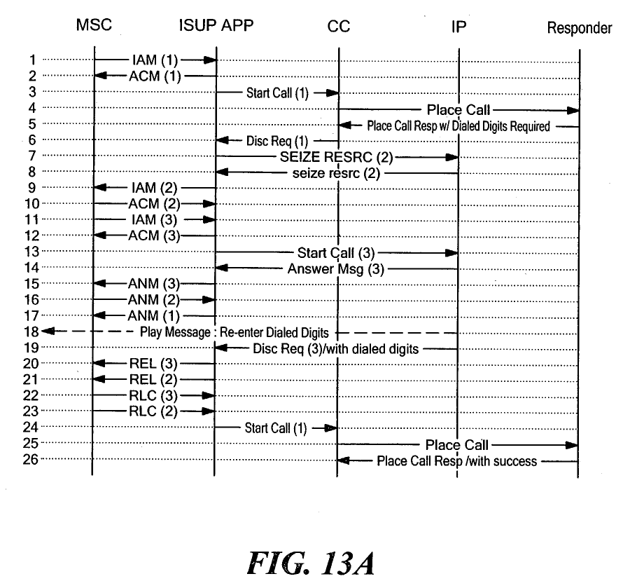

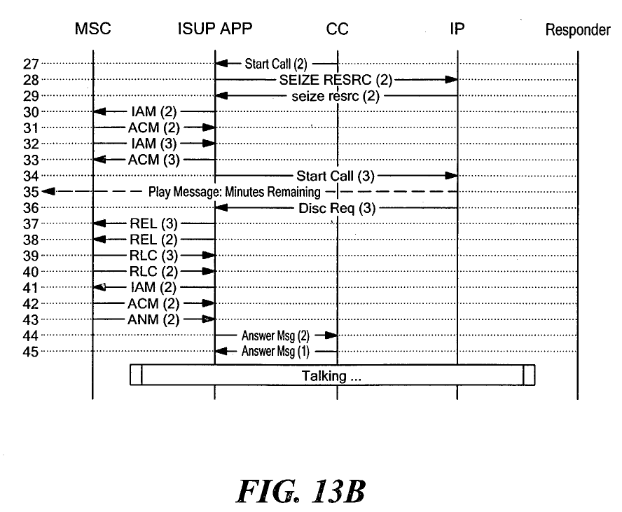

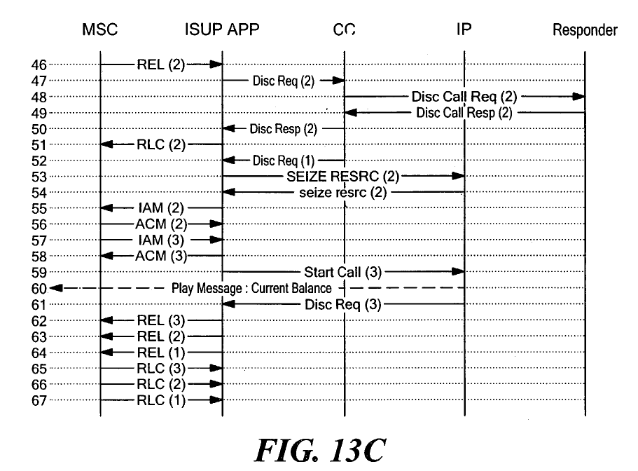

With reference to FIGS. 13A-13C, the Call Controller detects that a Hotline Roaming call has been received and indicates this in a PlaceCall Request sent to the Responder (line 4). The Responder replies with a “Dialed Digits Required” response, which ultimately invokes a message voiced by the Intelligent Peripheral that requires the subscriber to re-enter the originally dialed number (lines 5-18). The Intelligent Peripheral collects the digits dialed by the subscriber and returns them to the Responder via the ISUP Application and Call Controller (lines 19-25). Call processing then proceeds as it would for a normal outbound call.

Screening of Roaming Services for Non-Subscribers

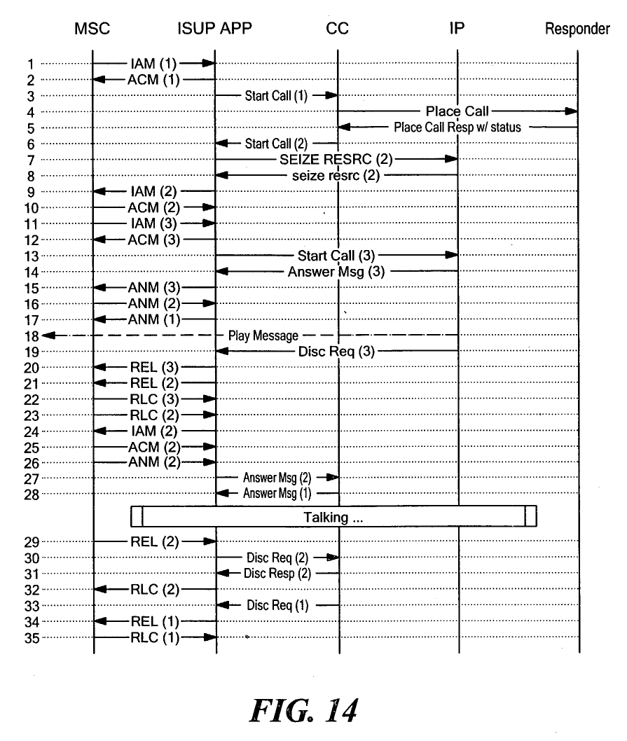

By pre-negotiated agreement, a carrier refers unregistered roamers in its market to a centralized roamer servicing platform such as that presently disclosed. With reference to FIG. 14, an MSC initiates a call to the ISUP Application, which in turn signals the Call Controller of the new call (lines 1-3). The Call Controller signals the Responder of the new call and indicates that non-subscriber roaming is enabled (line 4). Once the Responder determines that the caller does not have a account in the subscriber database, it sends the Call Controller a message indicating a call should be placed to the caller for the Intelligent Peripheral to voice of a message indicating the non-subscriber roaming service is available (line 18).

However, before this occurs, the Call Controller is programmed to recognize the message from the Responder and to refer to a Call Controller-associated “Denial Table” database to search for the MIN of the non-subscriber roamer. If the caller's MIN appears in the Denial Table, the Call Controller discards the script information received from the Responder and sends the ISUP Application a disconnect message, thus terminating the call without offering the non-subscriber roaming service.

If, on the other hand, the caller's MIN is not found in the Denial Table by the Call Controller, the ISUP Application is instructed to issue a resource request to the Intelligent Peripheral (or to identify the resource from local storage, in an alternative embodiment) (lines 6-7). An interactive session between the caller and the Intelligent Peripheral ensues, in which the Intelligent Peripheral voices a message indicating that the caller is to be transferred to an alternative billing platform where the call can be charged to a credit card, wireline system calling card, or as a collect call.

Assuming a proper payment vehicle has been identified to the Intelligent Peripheral and forwarded to the Responder via the ISUP Application, The ISUP Application ultimately issues a new call request to the MSC along with the originally requested number (line 24), and the calling and called parties are connected (lines 25-28). The case where the called party hangs up first is illustrated in FIG. 14, line 29, though it is understood that the calling party could also be the one to initiate the subsequent call tear-down.

What is claimed is:

1. A method of authorizing and accounting for wireless communications services using a system of interconnected elements comprising a switching point, an intelligent peripheral, a call controller, a database interface and a subscriber database, the method comprising the steps of:
interfacing the switching point with external telecommunications switching equipment;
receiving at the switching point a message from the external telecommunications switching equipment indicative of a request for establishment of a communications session between a calling party and a called party, at least one of which being a subscriber to services authorized and accounted for by the system;
establishing a signaling link between the switching point and the intelligent peripheral;
providing the external telecommunications switching equipment with a resource value from the switching point with which the external telecommunications switching equipment can establish communications with the intelligent peripheral; and
establishing a communications session between the external telecommunications switching equipment and the intelligent peripheral.
